(19) United States
(12) Patent Application Publication
(10) Pub. No.: US 2013/0337497 A1
(43) Pub. Date: Dec. 19, 2013

(54) MAGNETIC FLOW CYTOMETRY FOR HIGH SAMPLE THROUGHPUT

(71) Applicants: Oliver Hayden, Herzogenaurach (DE); Michael Johannes Helou, Regensburg (DE); Mathias Reisbeck, Obertraubling (DE); Sandro Francesco Tedde, Erlangen (DE)

(72) Inventors: Oliver Hayden, Herzogenaurach (DE); Michael Johannes Helou, Regensburg (DE); Mathias Reisbeck, Obertraubling (DE); Sandro Francesco Tedde, Erlangen (DE)

(21) Appl. No.: 14/001,996

(22) PCT Filed: Feb. 22, 2012
(86) PCT No.: PCT/EP2012/052977

§ 371 Date: Aug. 28, 2013

(30) Foreign Application Priority Data
Feb. 28, 2011 (JP) 102011004806.5

(51) Int. Cl. G01N 27/74

(52) U.S. Cl. CPC G01N 27/745
USPC 435/34; 435/287.1; 438/3

(57) ABSTRACT

In a measuring device, a production thereof, and a use thereof for magnetic flow cytometry, a microfluidic channel is disposed along an enrichment route such that a magnetically marked cell sample flowing through the microfluidic channel is aligned to magnetic guide strips, enriched by the magnetic field of a magnet at the floor of the channel, and guided past a sensor. The enrichment route is thereby implemented with the microfluidic channel on the packaging of the semiconductor chip carrying the sensor. This construction ensures a long enrichment route for high throughput of large sample volumes.

### CROSS REFERENCE TO RELATED APPLICATIONS

This application is based on and hereby claims priority to International Application No. PCT/EP2012/052977 filed on Feb. 22, 2012 and German Application No. 10 2011 004 806.5 filed on Feb. 28, 2011, the contents of which are hereby incorporated by reference.

### BACKGROUND

The present invention relates to magnetic cell detection in flow.

In the field of cell measurement and cell detection, besides optical measurement methods such as scattered-light and fluorescence measurement, magnetic detection methods in which the cell species to be detected is marked by magnetic labels are also known.

In particular, for magnet-based measurement, methods in which magnetically marked cells are sorted by magnetophoresis from a complex cell suspension, for example a blood sample, are known. To this end, this complex suspension would first need to be prepared in such a way that cells to be detected can be separated therefrom. The magnetic marking is carried out, in particular, by introducing cell-specific markers into the complex cell sample. Magnetophoresis has previously been used for sorting magnetically marked cells or, in general, magnetic particles.

In the field of magnetoresistive sensor technology for cell detection, however, it is also possible to count magnetically marked cells dynamically in a complex suspension flowing through. To this end, it is important that the cells flow individually in succession over the sensor, and that the magnetically marked cells are moved over the magnetoresistive in sufficient proximity thereto.

In a magnetic flow cytometer, marked cells are therefore transported in a channel near the surface over a magnetic sensor. The proximity of a magnetically marked cell to the sensor is crucial since the stray magnetic field of the magnetic markers, with the aid of which the marked cells are ultimately detected by the sensor, decreases with the third power of the distance.

In order to ensure that a marked cell moves past the sensor in immediate proximity thereto, it is in principle conceivable to make the diameter of the channel through which the cell sample flows as small as possible. That is to say, in the extreme case the channel diameter is just large enough for individual cells to be able to pass through. A problem with this, naturally, is that the presence of impurities or interfering particles very rapidly leads to obstruction of the channel.

If the channel is made larger, however, the likelihood increases that some marked cells will pass the sensor outside its range and therefore not be detected. This can be counteracted by enriching the magnetically marked cells at the sensor: it has been found that an enrichment path which is as long as possible through a microfluidic channel, of up to 1 cm in length, has the positive effect that almost 100% of the magnetically marked cells from the complex suspension can be enriched on the channel bottom at the end of the enrichment path, in such a way that detection by a magnetic sensor is possible.

### SUMMARY

However, arranging such a long enrichment path on a semiconductor substrate, on which the magnetoresistive component is formed, leads to a high aspect ratio of the substrate, which, besides high costs for the total area of the semiconductor substrate, particularly for silicon dice, also leads to problems during the processing in the production process. The greater the speed of the flow and the higher the cell concentration in the sample, the longer the alignment path must be selected to be in order to ensure sufficiently sufficient enrichment of the magnetically marked cells at the time when they pass over the sensor.

It is one potential object to provide a device for magnetic cell detection, which makes it possible to reduce the size of the semiconductor chip with an increase in the sample throughput volume.

The inventors propose a device for magnetic flow cytometry , an associated production method and a magnetic cell detection method. The device for magnetic flow cytometry proposed by the inventors comprises a magnetoresistive sensor on a substrate, and an enrichment path. The enrichment path comprises a first section and a second section. The second section of the enrichment path is arranged on the substrate and the first section of the enrichment path is arranged next to the substrate on a carrier, so that the enrichment path extends over an edge of the substrate.

In order to form an enrichment path which is as long as possible, without unnecessarily increasing the size of the semiconductor substrate on which the magnetoresistive sensor is constructed, the enrichment path is formed next to the substrate. In particular, the enrichment path and substrate share a common carrier, for example a printed circuit board. The semiconductor substrate with the sensor is applied and electrically connected onto this printed circuit board, and in this form introduced into a package in such a way that the electrical contacts are insulated and protected against corrosion as well as mechanical damage. On this carrier substrate, or on the packaging material which is applied onto the carrier substrate, the enrichment path can now be configured with any desired length. For example, the enrichment path may be configured in a meandering shape and extend in a plurality of tracks, which are joined by bends, until they reach the semiconductor chip with the sensor. In particular, the packaging material is used in order to form a flow chamber through which a cell sample can flow.

The packaging is carried out, in particular, in an injection molding method by which a flow chamber can be produced.

The enrichment path advantageously comprises magnetic guide strips, which in particular are ferromagnetic. For example, nickel may be envisioned as a ferromagnetic material for the guide strips. Ferromagnetic alloys may also be used for this purpose.

In an advantageous configuration, the flow chamber, in particular a microfluidic channel, is formed along the enrichment path in such a way that a magnetically marked cell sample flowing through the microfluidic channel is aligned on the magnetic guide strips of the enrichment path. That is to say, the magnetic guide strips and the magnetically marked cells interact in such a way that the cells experience alignment within the cell suspension, so that the stray field of their magnetic label leads to a signal that is as high as possible over the sensor.

In another advantageous configuration, the device comprises a magnet which is arranged in such a way that a magnetically marked cell sample flowing through the microfluidic channel is enriched on the channel bottom by the magnetic field of the magnet. That is to say, in addition to the guiding by the magnetic guide strips, the magnetic field of a magnet, in particular a permanent magnet, exerts a magnetic force on the marked cells within the cell suspension and moves them in a direction from the cell suspension toward the channel bottom.

This enrichment and alignment of the magnetically marked cells has the advantage that the concentration of the magnetically marked cells is increased in the vicinity of the channel bottom, and thus in the vicinity of the magnetoresistive sensor. The sensor is expediently applied on the channel bottom in such a way that it can detect substantially all the marked cells. If the cells are still distributed uniformly throughout the sample volume before the enrichment and alignment, the enrichment and alignment lead to individual cell detection at the sensor being ensured.

In an advantageous configuration, a first section and a second section of the microfluidic channel, as well as the magnetoresistive sensor, are arranged in such a way that a magnetically marked cell sample flowing through the microfluidic channel is guided first by the first section of the microfluidic channel over the first section of the enrichment path, then by the second section of the microfluidic channel over the second section of the enrichment path and over the sensor. In this case, the respective second sections of the microfluidic channel and of the enrichment path are configured in such a way that they can correct an offset from the respective first sections of the microfluidic channel and of the enrichment path. Such an offset may occur when combining the substrate, on which the magnetoresistive sensor is arranged, and the carrier on which the substrate is in turn arranged. The effect of the respective second sections of the microfluidic channel and of the enrichment path is that this offset is corrected at least in relation to the enrichment and alignment of the flowing magnetically marked cell sample. That is to say, the magnetically marked cells arriving at the sensor are enriched on the channel bottom and aligned in such a way as if there were no offset within the enrichment path due to the transition from the carrier to the substrate.

In particular, the enrichment path has a minimum length of at least 15000 μm. In this case, however, the substrate has in particular a largest dimension of at most 18000 μm. Since, in particular, semiconductor substrates such as silicon can entail high costs, the small area requirement is of great advantage. The small required area of semiconductor substrate is ensured by the fact that there only has to be an enrichment path section on the substrate which is just long enough to compensate for an offset when the substrate is mounted on the carrier. The main part of the enrichment and alignment, however, can take place in the first section of the enrichment path on the carrier.

It has been found that the minimum length of the enrichment path has the advantage that, at the end of the enrichment path, even highly concentrated cell samples can be enriched on the channel bottom and aligned along the magnetic guide lines of the enrichment path in such a way that individual cell detection is ensured at the time when they pass over the magnetoresistive sensor.

When the semiconductor chip and carrier are combined, a small offset which is typically less than 100 μm may occur. That is to say, the first part of the enrichment path is aligned with a point other than that where the magnetoresistive sensor is actually arranged. In order to compensate for this, an enrichment path which comprises ferromagnetic strips, by which the enriched and aligned cells are concentrated toward the sensor, is also formed on the semiconductor chip on the last part of the microfluidic channel to the sensor. In particular, the cells follow the laminar flow profile. For enrichment of the cells on the channel bottom as close as possible to the sensor surface, the magnetic cells are exposed to a magnetic gradient field which, for example, is generated by a permanent magnet below the component arrangement or by two magnets, above and below the flow cytometer.

The magnetoresistive sensor of the device is, in particular, a GMR sensor (GMR=Giant MagnetoResistance), and for example the magnetoresistive sensor of the device is a TMR sensor (TMR=Tunnel MagnetoResistance) or the magnetoresistive sensor of the device is an AMR sensor (AMR=Anisotropic MagnetoResistance).

The production of a device as described above comprises the steps of producing the magnetoresistive sensor on a semiconductor substrate, applying the second section of the enrichment path onto the semiconductor substrate, packaging the semiconductor substrate onto a carrier and leading out the electrical contacts of the magnetoresistive sensor onto the carrier, and finally forming a first section of the enrichment path. This method has the advantage that a small semiconductor substrate area is used in such a way that a large enrichment path can be constructed. The packaging of the semiconductor chip is a conventional method of microsystems technology, which is used for insulation, corrosion protection and protection against damage to the contacts, and for fastening the semiconductor chip on a carrier, for example a printed circuit board. The packaging and the carrier are, for example, furthermore used in such a way that a long section of the enrichment path is formed on the carrier in such a way that the main enrichment and alignment takes place thereon before the cell suspension is delivered onto the semiconductor chip with the sensor.

The advantage resides, in particular, in the fact that for low-concentration samples of about 1 cell per μl, it is possible to produce large enrichment paths with a high-volume throughput, with low silicon consumption. The silicon die footprint is accordingly reduced as far as possible. “Die” refers for example to the unpackaged semiconductor chip, an integrated electronic component, the semiconductor substrate or sensor substrate. After the integrated sensor circuit has been produced on the semiconductor chip, it is encapsulated in a “package” in order to protect it against damage or corrosion. To this end, the semiconductor chip is first applied onto a carrier substrate and the electrical contacts of the integrated circuit are led out onto the carrier substrate. This is done, for example, by wire bonding or by through-contacts. For example, ceramics or polymers, such as epoxides, are used as material for the packaging. The packaging is thus necessary in order to provide a component which can be exposed to environmental influences. This example of an embodiment now offers the great advantage of using this packaging twofold, on the one hand by exploiting the additional area in order to arrange the enrichment path thereon, and on the other hand by the packaging material itself being used to form the flow chamber, this being done particularly in a single operation.

In an advantageous configuration, a microfluidic channel is formed in the method from the packaging material in packaging the semiconductor substrate. The packaging step may, in particular, be carried out by injection molding. In this way, a microfluidic channel can be formed by injection molding technology.

In an advantageous configuration, the magnetic guide strips of the enrichment path, in particular of the first section of the enrichment path, are deposited directly onto the channel bottom. For example, methods such as thermal evaporation or sputtering are used for this purpose. Owing to the formation of the microfluidic channel onto the packaging material, the magnetic guiding by the guide strips is thus arranged inside the channel.

For the part of the enrichment path which is arranged on the semiconductor substrate, the magnetic guide strips may in turn be deposited directly onto the semiconductor substrate. Again, thermal evaporation or a sputtering process may be used for this purpose.

For a magnetic cell detection method, a magnetically marked cell sample is injected into a device as described above having an enrichment path on an additional carrier substrate next to the semiconductor substrate.

The enrichment by an external field, for example the field of a permanent magnet, and the magnetophoretic alignment by the ferromagnetic guide tracks, is preferably carried out in-situ during the measurement process. A sufficiently long alignment path for the magnetically marked cells is therefore necessary in order to ensure a desired marked cell recognition rate of substantially 100%. Factors influencing the specifically required enrichment and alignment path length with the ferromagnetic tracks are
1. the speed with which the cell sample is pumped through the microfluidic channel,
2. the magnetic field strength of the applied enrichment magnetic field,
3. the concentration of the superparamagnetically marked cells in the suspension, as well as
4. the magnetic properties of the markers used,
5. the composition and rheological properties of the cell suspension, that is to say for example their flow property, and
6. the type of marked cells and the isotope number thereof on the cell surface, and therefore the number of paramagnetic markers per cell, determines the strength of the stray field to be detected.

The cell suspension is, in particular, pumped through the microfluidic channel by a pressure gradient. The pressure gradient may, for example, be generated by manual operation of a syringe or of a syringe system. This ensures that a laminar flow of the cell sample is set up without recirculation. Since the cells and the complex medium containing the cells have approximately the same density, only a small centrifugal force occurs even in the bend regions of the meandering fluidic channel, and the marked cells can remain on their path.

During the magnetic flow cytometry, it is thus crucial that the magnetically marked cells are transported past the magnetoresistive sensor very closely. Since the cell sample flows through a flow chamber, for example a microfluidic channel, the marked cells must be transported in this flow chamber close to its inner surface, where the magnetoresistive sensor is applied. In particular, the channel wall is applied in direct contact over the magnetic sensor. In alternative embodiments, the magnetoresistive sensor is embedded in the channel wall. Superparamagnetic labels are preferably used as magnetic marking. GMR, TMR or AMR sensors may be envisioned as magnetoresistive sensors. The proximity of the magnetically marked cell to the sensor is crucial because the magnetic stray field of the magnetic marking decreases in the near-field range with the third power of the distance. In addition to the enrichment of the magnetically marked cells on the sensor surface, alignment of the magnetically marked cells has a positive effect on their detectability. In this case, the magnetically marked cells are preferably aligned in the flow direction in such a way that the magnetic field of the magnetic marking induces a signal which is as clear as possible in the sensor. During the magnetic flow cytometry, maximally accurate differentiation between false positives and positive signals is necessary. To this end, for positive signals, a threshold value which is as high as possible may be used for the signal in order to distinguish it from noise signals.

In contrast to methods which pass magnetically marked cells individually over a sensor by constricting them in a microfluidic channel by its diameter in such a way that only individual cells can pass through it, the method has the advantage of allowing substantially 100% individual cell detection, directly from the unprepared complex suspension. The great disadvantage of, so to speak, mechanical individualization of the cells, namely that it leads to obstruction of the fluidic system, is therefore overcome. Furthermore, magnetically marked cells of different diameters could not individually be determined exactly in such a measurement device. The cells have, for example diameters in the range of about 3 to 30 μm. They are preferably passed through a very much wider microfluidic channel, the diameter of which is 10 to 1000 times as great. The sensor, or a sensor array, is in this case arranged transversely with respect to the flow direction and is for example 30 μm wide, corresponding to the cell diameter.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a cross section through a microfluidic channel and a substrate,

FIG. 2 shows the associated plan view with magnetic lines,

FIG. 3 again shows a cross section through a microfluidic channel and a substrate and

FIG. 4 shows the associated plan view with the magnetic lines.

FIG. 5 shows another cross section through a microfluidic channel and a substrate and

FIG. 6 shows another cross section through a microfluidic channel and a substrate,

FIG. 7 shows a meandering enrichment path,

FIG. 8 shows the magnetic guide lines in the first bend of the enrichment path.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

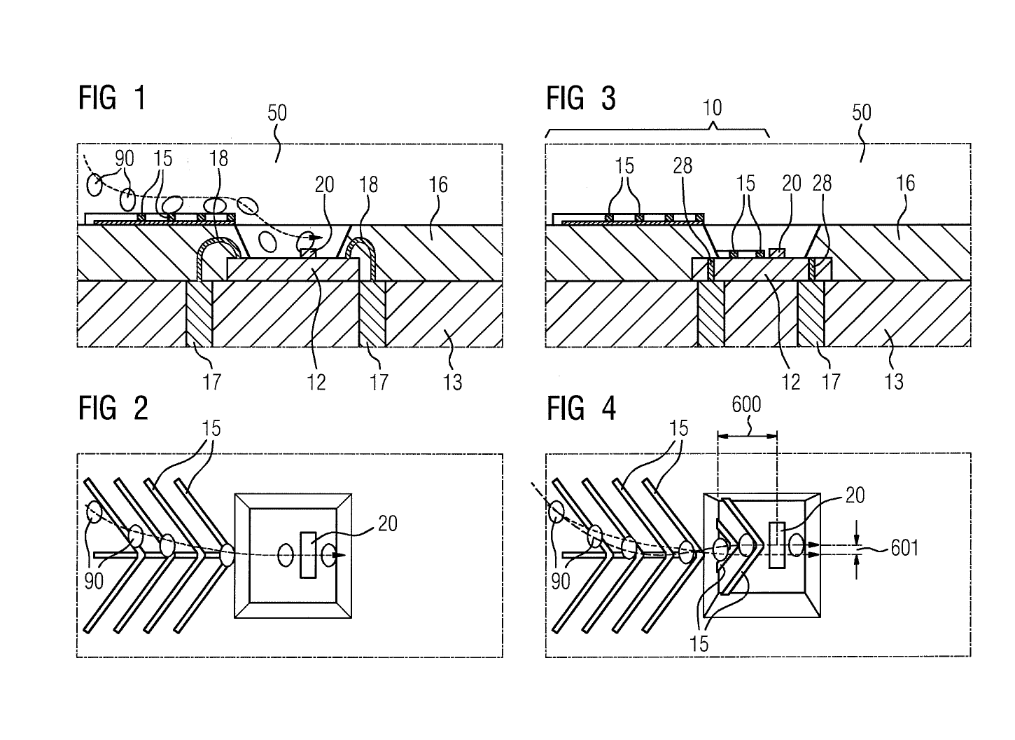

FIG. 1 shows a cross section through an embodiment of the measurement device, and FIG. 2 shows the associated plan view. FIG. 3 shows an alternative exemplary embodiment in cross section, and FIG. 4 shows the associated plan view.

The semiconductor chip 12, which is used as a substrate for the measurement sensor 20, is applied onto a carrier plate 13. The carrier plate 13 is for example a printed circuit board for electronic components, in particular a copper printed circuit board. This printed circuit board 13 comprises contacts 17 which for example, as shown in FIGS. 1a and 2a, constitute feeds through the carrier plate 13. That is to say, they electrically connect the upper side and lower side of the carrier plate 13. The contacts of the measurement sensor 20 on the semiconductor chip 12 are connected to these through-contacts, or contacts, 17 by wire bonding and accordingly electrical wire connections 18, as shown in FIG. 1, or alternatively are electrically connected with so-called through silicon vias 28 to the contacts 17 of the carrier plate 13, as shown in FIG. 3.

The packaging material 16 is deposited over a part of the semiconductor chip 12, in particular the part with the electrical contacts 18, 28, and therefore connects the semiconductor chip 12 to the printed circuit board 13. By the packaging material 16, the contacts 17, 18, 28 are electrically insulated and protected against corrosion or mechanical damage. The part of the semiconductor chip 12 which remains free of the packaging material 16 comprises the magnetoresistive sensor 20. A cell sample 90 can now flow over the packaging material 16 onto this exposed region of the semiconductor chip with the sensor 20. To this end, the enrichment path 10 is arranged over the edge of the substrate 12. As indicated by the magnetically marked cells 90 and the dashed arrows, a flow of the cell sample 90 is generated over the sensor 20. To this end, in particular, a permanent magnet is arranged above or below the measurement device, in the magnetic field of which permanent magnet the marked cells 90 are enriched on the packaging material 16 and on the semiconductor chip 12, that is to say they are guided toward the packaging material 16 and the semiconductor chip 12 in the magnetic field. Besides the enrichment of the cells 90 on the sensor surface, the cells 90 are additionally aligned along magnetic guide lines 15, which are also respectively to be seen in cross section and plan view in FIGS. 1a to 2b. In the cross section, it can only be seen that the individual magnetic guide lines 15 guide onto a central portion of the enrichment path 10 in the direction of the magnetic sensor 20. In the plan view in FIGS. 1b and 2b, the preferred arrangement configuration of the magnetic field lines 15 is shown, which has the appearance of a herringbone pattern. The magnetic guide lines 15 are oriented at an angle of less than 90° onto the midline of the enrichment path 10, and therefore guide the magnetically marked cells 90 from the edge of the enrichment path 10 toward the central section of the enrichment path 10, so that they can be guided centrally over the magnetoresistor 20.

The majority of the enrichment path 10, which extends beyond the edge of the substrate 12, lies on the packaging material 16, which can be deposited with an area that is as large as desired. That is to say, the carrier base plate 13 determines the total size of the measurement device. Large enrichment paths 10 can be produced simply and economically thereon. When the magnetically marked cells 90 reach the semiconductor chip 12 with the sensor 20, they are already enriched on the sensor surface and are correspondingly aligned. Nevertheless, the short path on the semiconductor chip 12 before the sensor 20 again comprises a short enrichment path 600, which is used so that a possible offset 601 of the enrichment path on the packaging material 16 with respect to the sensor 20 can be compensated for. Such an offset 601, as marked in FIG. 4, may occur during mounting of the semiconductor chip 12 on the carrier 13. Minor offsets 601, however, can be compensated for by a short enrichment path 600 without a further long enrichment path 10 being necessary. Short enrichment paths 600 on the semiconductor chip 12, which do not substantially increase its total size, are moreover therefore sufficient for guiding the magnetically marked cells 90 centrally over the sensor 20.

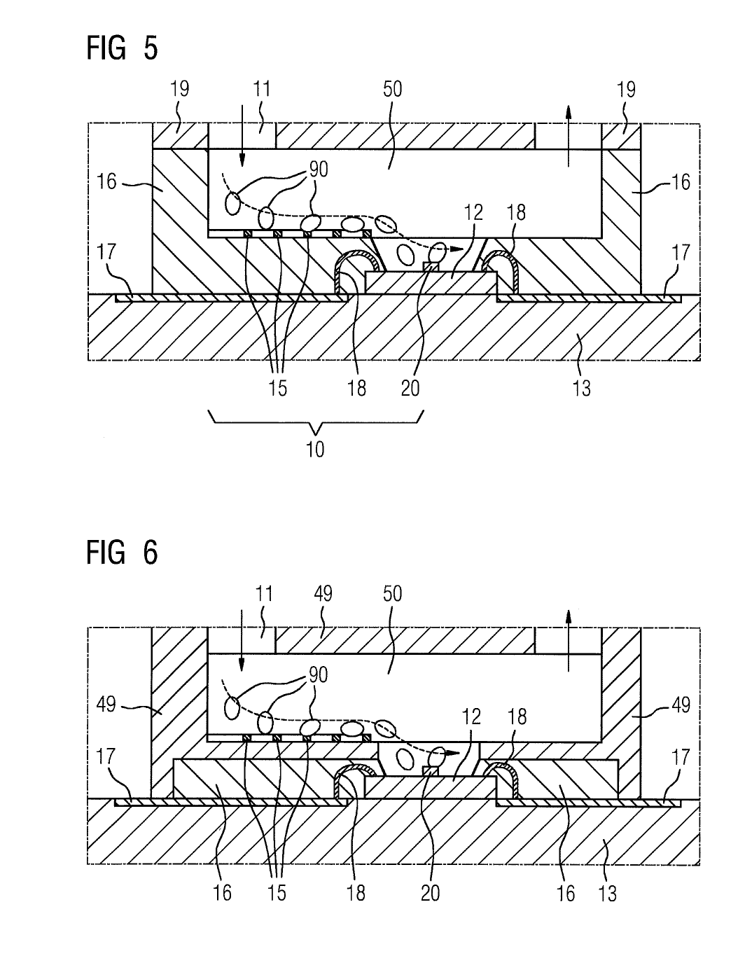

FIG. 5 shows a possible embodiment of the microfluidic channel 50 on a measurement device. Again, FIG. 5 shows a carrier substrate 13 onto which the semiconductor chip 12 is contacted by wire bonds 18. Also shown once more is the packaging 16, which insulates and protects the electrical contacts 17, 18. The cross section through the magnetic guide lines 15, along which the magnetically marked cells 90 are guided, is furthermore shown. The surface of the packaging material 16 and of the semiconductor chip 12 constitute, so to speak, the bottom of the microfluidic channel 50, on which the magnetically marked cells 90 are enriched. The packaging material 16 is applied, particularly by an injection molding method, in such a way that a microfluidic channel 50 through which the cell sample 90 can be guided is formed. In particular, this channel 50 comprises an inlet and outlet 11 for the cell sample 90, which are denoted in FIG. 5 by arrows pointing inward and outward. FIG. 5 shows an example in which the channel wall is formed by the packaging material 16 and in which the measurement device, or the microfluidic channel 50, is sealed at the top by encapsulation 19.

FIG. 6 in turn shows a cross section through an alternative embodiment. In contrast to FIG. 5, the packaging material 16 is not configured as a channel wall for this purpose; rather, after the packaging step seals the electrical contacts 17, 18, a further material 49, which is to be processed by injection molding and from which the microfluidic channel 50 is formed, is deposited onto the carrier plate 13 and over the packaging material 16.

The cross section shows that the microfluidic channel 50 is again sealed at the top and merely comprises an inlet and outlet 11, which are marked by arrows. It is also shown that the magnetically marked cells 90 are again enriched on the channel bottom, i.e. on the substrate 12, in particular the magnetic guide lines 15, and subsequently on the semiconductor chip 12 and the sensor 20.

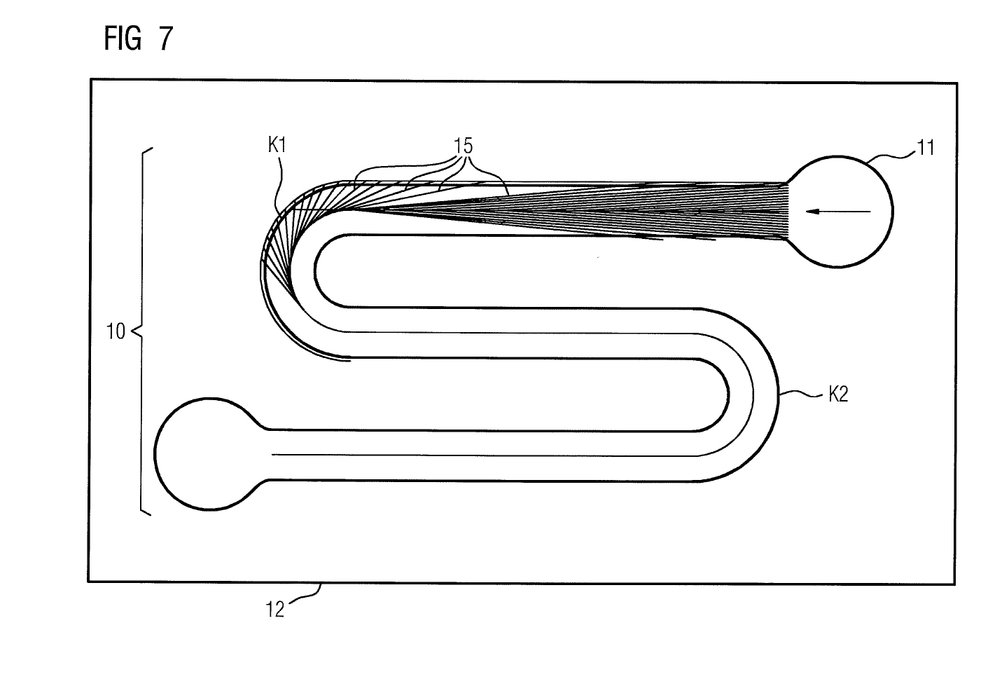

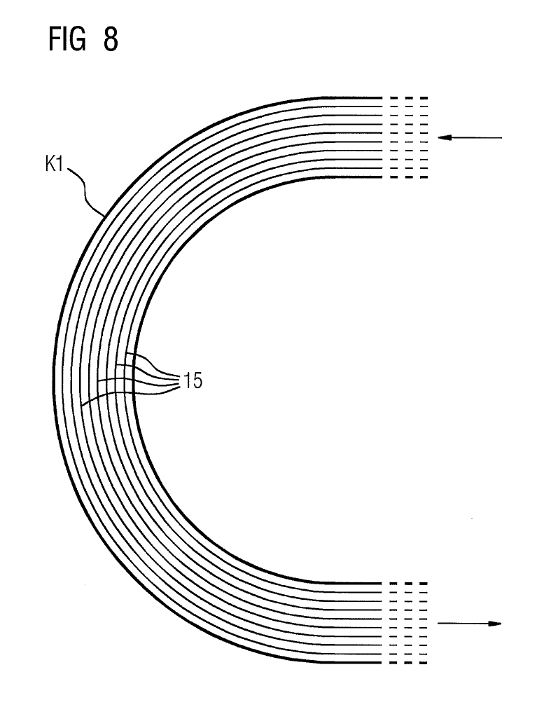

FIG. 7 shows a plan view of a meandering enrichment path 10. The enrichment path 10 comprises three straight subsections, which are joined to one another by two bends K1, K2. The enrichment path 10 is configured on the one hand for alignment, but also for enrichment of magnetically marked cells 90 on the channel bottom. That is to say, FIG. 7 shows a microfluidic channel 50 which is applied along the enrichment path 10 in such a way that a cell sample 90, which is guided through this microfluidic channel 50, experiences the magnetic forces of a permanent magnet for enrichment on the channel bottom as well as the alternating magnetic effect with the magnetic guide lines 15. The magnetic guide lines 15 shown in FIG. 7 extend along the enrichment path 10 directly on the substrate 12, which in particular is the surface of a semiconductor chip. Along the first straight subsection, the magnetic guide lines 15 converge at an acute angle on a midline of the enrichment path 10, and therefore guide the magnetically marked cells 90 into the middle of the channel. Along the first bend K1, the magnetic guide lines 15 extend from the edge of the enrichment path 10, i.e. also from the edge of the microfluidic channel 50, to the middle of the enrichment path 10. In this example, a central magnetic guide line is shown, which is always arranged along the middle of the channel. Furthermore, FIG. 7 shows an inlet 11 for admitting a cell sample into the microfluidic channel in the plan view of the enrichment path 10.

FIG. 8 shows a detail of the enrichment path 10 with the first bend K1 of the enrichment path. An alternative embodiment of the magnetic guide lines 15 is shown in FIG. 8. Instead of converging in the shape of a fan on the midline, they may also be semicircular lines of different radii, which respectively describe a track at a fixed distance from the channel walls of the microfluidic channel 50. In this example, the magnetically marked cells 90 in the cell sample are guided through the bend K1 on these tracks. The arrows indicate the flow direction of the cell sample through the bend K1 of the enrichment path 10.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A device for magnetic flow cytometry, comprising:
a carrier;
a substrate on the carrier, the substrate having an edge bordering the carrier;
a magnetoresistive sensor on the substrate; and
an enrichment path comprising a first section and a second section, the second section being arranged on the substrate and the first section being arranged next to the substrate on the carrier, so that the enrichment path extends over the edge of the substrate.

17. The device as claimed in claim 16, wherein the enrichment path comprises magnetic guide strips.

18. The device as claimed in claim 17, wherein the magnetic guide strips are ferromagnetic.

19. The device as claimed in claim 17, wherein
a microfluidic channel is formed along the enrichment path such that a magnetically marked cell sample flows through the microfluidic channel, and
the magnetic guide strips align the magnetically marked cell sample as it flows through the microfluidic channel.

20. The device as claimed in claim 16, wherein
a microfluidic channel is formed along the enrichment path such that a magnetically marked cell sample flows through the microfluidic channel, and
the device further comprises a magnet arranged such that the magnetically marked cell sample flowing through the microfluidic channel is enriched at a bottom of the microfluidic channel by a magnetic field of the magnet.

21. The device as claimed in claim 16, wherein
a microfluidic channel is formed along the enrichment path such that a magnetically marked cell sample flows through the microfluidic channel,
the microfluidic channel has a first section and a second section,
the first section of the microfluidic channel guides the magnetically marked cell sample over the first section of the enrichment path,
the second section of the microfluidic channel guides the magnetically marked cell sample over the second section of the enrichment path and over the sensor,
the first section of the microfluidic channel is offset from the second section of the microfluidic channel in a first offset, and
the first section of the enrichment path is offset from the second section of the enrichment path in a second offset,
the second section of the microfluidic channel and the second section of the enrichment path provide alignment and enrichment compensation for the first and second offsets.

22. The device as claimed in claim 16, wherein the enrichment path has a length of at least 15000 μm.

23. The device as claimed in claim 16, wherein the substrate is a semiconductor substrate.

24. The device as claimed in claim 23, wherein the substrate has a largest dimension of 18000 μm or less.

25. The device as claimed in claim 16, wherein the magnetoresistive sensor comprises at least one sensor selected from the group consisting of a Giant MagnetoResistance (GMR) sensor, a Tunnel MagnetoResistance (TMR) sensor and an Anisotropic MagnetoResistance (AMR) sensor.

26. A method for producing a device for magnetic flow cytometry, comprising:
producing a magnetoresistive sensor on a semiconductor substrate, the magnetoresistive sensor having electrical contacts;
forming a second section of an enrichment path on the semiconductor substrate;
packaging the semiconductor substrate onto a carrier and leading out the electrical contacts of the magnetoresistive sensor on the carrier, the substrate having an edge bordering the carrier; and
forming a first section of the enrichment path next to the substrate on the carrier, so that the enrichment path extends over the edge of the substrate.

27. The method as claimed in claim 26, wherein
the semiconductor substrate is packaged on the carrier with a packaging material, and
packaging the semiconductor substrate comprises forming a microfluidic channel from the packaging material.

28. The method as claimed in claim 27, wherein the microfluidic channel is formed by injection molding.

29. The method as claimed in claim 26, wherein
the enrichment path comprises magnetic guide strips, and
a microfluidic channel is formed along the enrichment path, and
the magnetic guide strips of the first section of the enrichment path are deposited directly onto a bottom of the microfluidic channel.

30. The method as claimed in claim 26, wherein
the enrichment path comprises magnetic guide strips, and
a microfluidic channel is formed along the enrichment path, and
the magnetic guide strips of the first section of the enrichment path are deposited directly onto a bottom of the microfluidic channel by thermal evaporation or sputtering.

31. The method as claimed in claim 26, wherein
the enrichment path comprises magnetic guide strips, and
the magnetic guide strips of the second section of the enrichment path are deposited directly onto the semiconductor substrate.

32. The method as claimed in claim 26, wherein
the enrichment path comprises magnetic guide strips, and
the magnetic guide strips of the second section of the enrichment path are deposited directly onto the semiconductor substrate by thermal evaporation or sputtering.

33. A method for magnetic cell detection, comprising:
injecting a magnetically marked cell sample into a microfluidic channel of a device comprising:
a carrier;
a substrate on the carrier, the substrate having an edge bordering the carrier;
a magnetoresistive sensor on the substrate; and
an enrichment path comprising a first section and a second section, the second section being arranged on the substrate and the first section being arranged next to the substrate on the carrier, so that the enrichment path extends over the edge of the substrate, the microfluidic channel extending along the enrichment path.
